(19) United States
(12) Patent Application Publication
(10) Pub. No.: US 2013/0004408 A1
(43) Pub. Date: Jan. 3, 2013

(54) Moderate Temperature Synthesis of Mesoporous Carbon

(76) Inventors: Rubal Dua, Thuwal (SA); Peng Wang, Thuwal (SA)

(21) Appl. No.: 13/539,703

(22) Filed: Jul. 2, 2012

Related U.S. Application Data
(60) Provisional application No. 61/503,201, filed on Jun. 30, 2011.

(51) Int. Cl. C01B 31/08; C01B 31/10; C01B 31/12

(52) U.S. Cl. 423/445 R

(57) ABSTRACT

Methods and composition for preparation of mesoporous carbon material are provided. For example, in certain aspects methods for carbonization and activation at selected temperature ranges are described. Furthermore, the invention provides products prepared therefrom.

### CROSS-REFERENCE TO RELATED APPLICATIONS

This application claims priority to U.S. Provisional Application No. 61/503,201 filed Jun. 30, 2011, the entire contents of which is specifically incorporated herein by reference without disclaimer.

### BACKGROUND OF THE INVENTION

1. Field of the Invention

The present invention relates generally to the field of a mesoporous carbon material, a method of preparing the same and applications using the carbon material, and more particularly, to a method of preparing a desired carbon material from biomass obviating the need for high temperatures.

2. Description of Related Art

Porous carbon materials have been used extensively in various industries such as water, food, chemical processing, pharmaceutical, gold mining, as catalysts, as electrode materials, etc. (Lee et al., 2006). The various kinds of porous carbon materials are divided into three categories based on their pore size distribution, micropore dominated (pore size <2 nm), mesopore dominated (pore size between 2-50 nm), macropore dominated (pore size >50 nm). Until recently, the most commonly used form of porous carbon has been the micropore dominated form (Hu and Srinivasan, 2001) more commonly known as activated carbon. However lately, there has been a lot of interest in mesopore dominated carbons. Because of their large pore size, they are easily accessible for even larger size molecules and also suffer less from the phenomena of pore blockage (Hu et al., 2000). For example, in case of water purification, mesopore dominated carbons give faster sorption kinetics and are also able to adsorb large size molecules such as dyes (Zhuang et al., 2009) and humics (Ariga et al, 2007) unlike micropore dominated carbons. Thus, there is a lot of interest in synthesis of mesopore dominated carbons with high surface area, where high surface area is imperative for superior performance (Zhuang et al., 2009). The techniques (Lee et al., 2006; Liang et al., 2008) for synthesizing mesoporous carbon materials can be divided into three categories: traditional activated carbon route (Hu and Srinivasan, 2001), hard templating route (Jun et al., 2000) and the soft templating route (Meng et al., 2005). The hard and soft templating routes involve: the use of costly self-assembly directing agents (such as surfactants), synthesis of sacrificial scaffolds such as mesoporous silica from costly silica precursors, work with limited carbon precursors only and involve a high temperature carbonization step. Also the mesoporous carbons synthesized via these two approaches possess low-medium surface areas (˜600-900 m²/g). Currently, among the three approaches, only the traditional activated carbon route offers any advantage of utilizing waste biomass as the carbon precursor. However, the traditional activated carbon route generally results in micropore dominated carbons. Hu et. al. developed a combined physical and chemical activation approach for producing high surface (˜2100 m²/g) area mesopore dominated carbons (˜71% mesoporosity based on pore volume) (Hu et al., 2000). But it involves a long duration high temperature step (700-900° C. for 2-3 h), and is thus very energy-intensive and costly.

Therefore, there remains a need for a more energy efficient method for producing high surface area mesoporous carbons at relatively lower temperatures as compared with prior art.

### SUMMARY OF THE INVENTION

Aspects of the present invention overcome a major deficiency in the art by providing novel methods for preparing a mesoporous carbon material from a carbon precursor as well as products prepared therefrom. Embodiment of the invention include a combination of moderate temperature hydrothermal carbonization and moderate temperature activation to produce high surface area mesopore dominated carbons. In a first embodiment there is provided a method for obtaining a reaction mixture comprising of a carbon precursor and a solvent. In additional embodiments, the method may comprise a carbonization step by incubating the reaction mixture at a first temperature, wherein the carbon precursor is converted to a coal-like material. The first temperature may be at least, about or up to 20, 30, 40, 50, 60, 70, 80, 90, 100, 150, 200, 250, 300, 350, 400, 450, 500, 550, 600° C. or any range or value derivable therein, particularly in the range of about 90 to about 400° C.

The moderate temperature carbonization may be further combined with a moderate temperature activation step to provide mesoporous products. The activation step may comprise treating the coal-like material with an activating agent in an inert atmosphere at a second temperature, wherein the coal-like material is converted into a mesoporous carbon material. The second temperature may be at least, about or up to 20, 30, 40, 50, 60, 70, 80, 90, 100, 150, 200, 250, 300, 350, 400, 450, 500, 550, 600, 700, 800° C. or any range or value derivable therein, particularly in the range of about 300 to about 600° C.

The mesoporous carbon material may have at least, about or up to 10, 11, 12, 13, 14, 15, 16, 17, 18, 19, 20, 25, 30, 35, 40, 45, 50, 55, 60, 65, 70, 75, 80, 90, 95, 99, 99.5, or 99.9% (or any range or value derivable therefrom) contribution to the total pore volume or the total surface area of the carbon material by mesopores. In certain aspects, the mesopores may refer to pores having size in the range of about 2 to about 50 nm.

The reaction mixture may contain water or any other suitable solvent, such as an organic solvent. Non-limiting examples of organic solvents include ethanol, methanol, acetone, chloroform, pentane, cyclopentane, hexane, cyclohexane, benzene, toluene, 1,4-dioxane, diethyl ether, dichloromethane, tetrahydofuran, ethyl acetate, dimethylformamide, acetonitrile, dimethyl sulfoxide, formic acid, n-butanol, isoproponal, n-proponal, or acetic acid. The reaction mixture may have the carbon precursor at a weight percentage of at least, about or up to 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 90, 95, 99, 99.5, or 99.9% (or any range or value derivable therefrom) relative to the total weight of the reaction mixture.

The reaction mixture may further comprise an acid or a base for pH adjustment. For example, the acid may be sulphuric acid, HCl or HNO₃. In certain aspects, the base may be NaOH or KOH. The reaction mixture may have a pH of at least, about or up to −10, −9, −8, −7, −6, −5, −4, −3, −2, −1, 0, 1, 2, 3, 4, 5, 6, 7, 8, 9, 10, 11, 12, 13, 14, 15, 16, 17, 18, 19, 20, or any range or value derivable therefrom.

The carbon precursor may be any carbon-containing material. For example, the carbon precursor could be a biomass, a biomass waste, an industrial waste, and products derived from the above materials. In exemplary aspects, the biomass may be any kind of plant material or animal material or forestry material or material derived from the same. Examples of plant materials could be crops, agricultural food, wood, grass, leaves. Non-limiting examples of animal materials may include shells, horns, bones, teeth, beaks. Examples of materials derived from plant and animal materials could be cellulose, fructose, sucrose, lignin, hemi-cellulose, starch, chitin, keratin, collagen etc. The carbon precursor may also be a long chain organic compound such as polymers, plastics, carbohydrates and proteins, particularly biodegradable compounds or polymers.

The biomass waste may be any kind of plant waste, animal waste, human or human generated waste and materials derived from the above wastes. Example of plant wastes could be fruit pits, bagasse, husks, straws, chaff, dry fruit shells, crop residues, agricultural food waste, feed crop residues, wood wastes (such as wood flour, scrap wood, sawdust, chips and discards) etc. Example of animal wastes may include poultry litter, dairy manure, swine manure etc. Examples of human waste may include sewage sludge etc. Examples of human generated waste could be municipal solid waste. In further aspects, the industrial waste could be any biodegradable fraction from industrial wastes.

The reaction mixture may be incubated at a pressure of at least, about or up to 20, 30, 40, 50, 60, 70, 80, 90, 100, 150, 200, 250, 300, 350, 400, 450, 500, 1000, 2000, 3000, 4000, 5000, 6000, 7000, 8000, 9000, 10,000, 20,000, 22,000, 23,000 kPa or any range or value derivable therein. In a particular aspect, the pressure may be at a range of about 70 to about 22,000 kPa. For example, the reaction mixture may be incubated for at least, about, or up to 0.01, 0.05, 0.1, 0.5, 1, 2, 4, 8, 16, 24, 48, 96, 120 hours or any range or value derivable therein. The reaction mixture may be incubated in an autoclave, extruder or any suitable pressure reactors.

The activation step may involve chemical activation or physical activation, or both, to impart porosity to the coal-like material. For example, the activating agent could be a chemical agent, such as zinc chloride, calcium chloride, sodium hydroxide, potassium hydroxide, phosphoric acid, calcium carbonate, magnesium oxide, potassium carbonate, sodium carbonate, lithium carbonate, rubidium carbonate, cesium carbonate, sulphuric acid, nitric acid, or a combination thereof. In other aspects, the activating agent may be steam or carbon dioxide for physical activation.

In certain aspects, the activating agent and coal-like material may be mixed in the presence of a solvent, such as water or an organic solvent. Any suitable organic solvent may be used, e.g., the organic solvent is ethanol, methanol, acetone, chloroform, pentane, cyclopentane, hexane, cyclohexane, benzene, toluene, 1,4-dioxane, diethyl ether, dichloromethane, tetrahydofuran, ethyl acetate, dimethylformamide, acetonitrile, dimethyl sulfoxide, formic acid, n-butanol, isoproponal, n-proponal, or acetic acid. The mixture of the coal-like material and activating agent obtained by using a solvent may be further dried or used as such in the activation step. In alternative aspect, the activating agent and coal-like material may be mixed as solids.

In particular aspects, the weight or volume ratio between the activating agent and the coal-like material may be at least, about, or up to 0:1, 0.005:1, 0.01:1, 0.05:1, 0.1:1, 1:1, 2:1, 3:1, 4:1, 5:1, 6:1, 7:1, 8:1, 9:1, 10:1, 50:1 or any range or value derivable therein. In a more particular aspect, the weight ratio between the chemical activating agent and the coal-like material may be about 0:1 to about 10:1.

In further aspects, the coal-like material may be treated in an inert atmosphere. The inert atmosphere may comprise nitrogen, helium, argon, neon, krypton, xenon, radon, or sulfur hexafluoride. In other aspects, the inert atmosphere may be vacuum. The coal-like material may be incubated at a pressure of at least, about or up to 0.01, 0.1, 1, 2, 3, 4, 5, 6, 7, 8, 9, 10, 15, 20, 30, 40, 50, 60, 70, 80, 90, 100, 150, 200, 250 kPa or any range or value derivable therein. For example, the coal-like material may be treated for activation for at least, about, or up to 0.01, 0.05, 0.1, 0.5, 1, 2, 4, 5, 6, 7, 8, 9, 10, 20 hours or any range or value derivable therein.

In particular aspects, the ramp to obtain the second temperature in the activation step may be a selected value or range, such as at least, about or up to 0.01, 0.1, 1, 2, 3, 4, 5, 6, 7, 8, 9, 10, 15, 20 K/min. The coal-like material may be treated in a tubular furnace or gas reactor.

In some aspects, the carbonization step and activation step may occur sequentially or simultaneously, or overlapping at a time range. In further aspects, the method may further comprise washing the mesoporous material

In some further aspects, there may be provided a composition comprising a mesoporous material prepared by the method described above.

Embodiments discussed in the context of methods and/or compositions of the invention may be employed with respect to any other method or composition described herein. Thus, an embodiment pertaining to one method or composition may be applied to other methods and compositions of the invention as well.

As used herein the specification, “a” or “an” may mean one or more. As used herein in the claim(s), when used in conjunction with the word “comprising”, the words “a” or “an” may mean one or more than one.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” may mean at least a second or more.

Throughout this application, the term “about” is used to indicate that a value includes the inherent variation of error for the device, the method being employed to determine the value, or the variation that exists among the study subjects.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1: Schematic diagram of the synthesis procedure.

FIG. 2: N₂ adsorption-desorption isotherm and Dollimore pore size distribution for synthesized mesoporous carbons (KMC-1 and KMC-2) and commercial activated carbons (AC-Micro and AC-Meso).

FIG. 3: Maximum sorption for the four organic compounds: atrazine, diuron, rhodamine-B and tannic on to two commercial activated carbons (AC-Meso, ACMicro) and the two mesoporous materials (KMC-1, KMC-2) synthesized in this study.

### DESCRIPTION OF ILLUSTRATIVE EMBODIMENTS

### I. METHODS

The invention relates to synthesis of sustainable, high surface area mesoporous carbon materials from carbon precursors, e.g., waste biomass (such as date pits), via moderate temperature hydrothermal carbonization followed by moderate temperature chemical activation. For example, the synthesized carbon materials may have very high surface areas (for example, ˜1600-1900 m²/g) and high mesoporosity (for example ˜46-66% mesoporosity based on pore volume). The synthesized mesoporous carbon materials may give excellent removal capacities for various organic compounds from water, at par with and in some cases, even better than the commercially available mesoporous carbon materials. The kinetics of sorption may also be very fast, more than 80% removal in one hour. The high surface areas, high mesoporosity content, low temperature synthesis, high sorption capacities and fast kinetics for organic compound sorption, and production from sustainable raw material make it an excellent material for commercialization and a better choice over current available methods.

In literature, one of the best reported traditional activated carbon techniques for producing high surface area mesopore dominated carbon material from waste biomass involved high temperature (˜700-900° C. for 2-3 h), simultaneous carbonization (under N₂) and physical activation (with CO₂) of chemical (ZnCl₂) impregnated biomass (Hu et al., 2000). It does result in the synthesis of high surface area (˜2100 m²/g) mesopore dominated carbons (˜71% mesoporosity based on pore volume), but is very energy-intensive and thus costly. The methods provided in the present invention are thermally less intensive and thus cheaper. In addition, high surface area mesopore-dominated carbons prepared according to the methods described herein result in superior performance of these carbon materials as has been demonstrated in Examples for organic compound removal from water.

The other techniques for producing mesoporous carbon materials that are on the horizon are the hard templating and soft templating routes. Both involve the use of costly self-assembly agents (such as surfactants) and high temperature carbonization. The hard templating approach also involves synthesis of sacrificial mesoporous silica scaffolds from costly silica precursor and thus both the approaches are quite expensive. Moreover, both the hard and soft templating route can only work with limited carbon precursors, especially not with waste biomass.

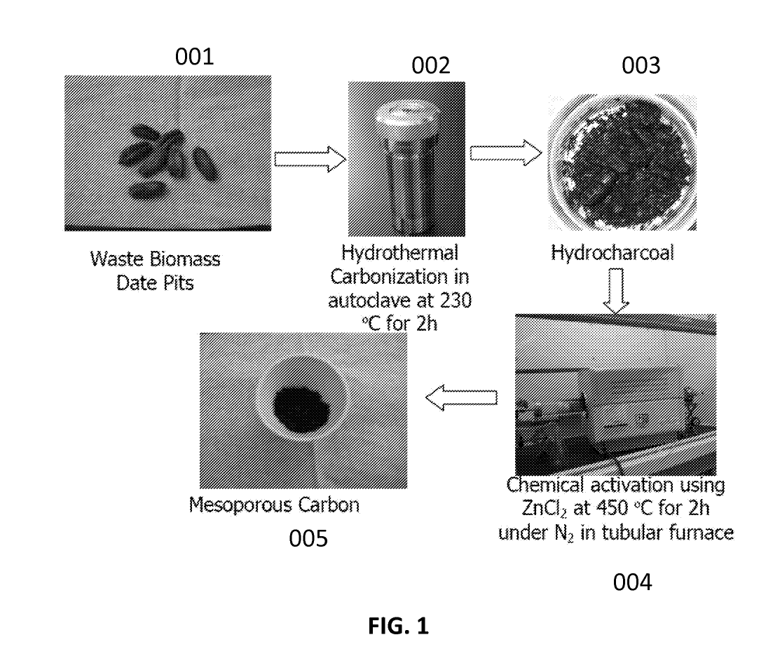

By reference to the appended FIG. 1, a preferred mode of carrying out the process for the preparation of mesoporous carbon materials according to the present invention will be illustrated. As can be seen, the process schematically shown in the flow diagram provided in the figure is a continuous process.

Reference numeral 001 denotes a starting material comprising a carbon precursor. For example, the carbon precursor may be a biomass waste, such as date pits. Preferably, the carbon precursor has a suitable particle size, e.g. in the range of about 0.1 to about 20 mm. The starting material 001 may be fed to a reactor 002 where it is mixed with further ingredients such as water and acid to give a reaction mixture. The reaction mixture may subject to hydrothermal carbonization, which may involve moderate temperatures and pressures over a carbon precursor suspension or solution.

In a particular embodiment, the reaction mixture may comprise water. The water being present in the reaction mixture may be water adhering or bound to the carbon precursor, such as biomass. As meant herein, biomass may for instance be the biomass obtained as waste (e.g. wood, agricultural, municipal waste) from the provider, without further treatment, or as collected from natural sources. In the case of wood, the biomass may be the wood collected in the forest (as the natural source), or sawdust from the wood processing industry. The water content of biomass may for instance be up to 80 wt %. As will be appreciated from the above, the biomass can be used as such and with water contents as mentioned above. Though drying is not excluded, e.g. in order to reduce the weight and consequently the transportation costs, the biomass to be subjected to the process of hydrothermal carbonization may not need to be dried. Consequently, certain aspects of the present invention may allow avoiding the energy-consuming drying of the biomass. The presence of water in certain aspects distinguishes this from e.g. pyrolytic processes for the conversion of biomass to coal-like materials by simple heating, typically in the absence of oxygen.

In addition to the water present in, e.g. bound to the biomass such as obtained from natural sources, water may be added to the wet or dry biomass to adjust the water content in the reaction mixture. The total amount of water, i.e. the water bound to or contained in the as-obtained biomass and the additional water is not specifically limited. Preferably, the weight ratio of water to the carbon precursor (e.g., water/biomass) in the reaction mixture is in the range of about 0.3 to about 10. For the ease of transportability, especially in a continuous process, the solid contents of the reaction mixture may be preferably 5 to 35%, more preferably 10 to 30%, especially 15 to 25% by weight. The reaction mixture having such solid contents may be preferably in the form of a slurry.

The hydrothermal carbonization process in reactor 002 can be carried out in water alone. Organic solvents such as ketones are unnecessary, and they may be omitted. In a particular embodiment, the reaction mixture contains water as a single solvent, with other solvents such as ethanol only incidentally brought in by the biomass, e.g. by fermentation. For example, at least 95 wt %, more particularly at least 98 wt % of the solvent present in the reaction mixture in reactor 002 is water.

In further aspect, the carbon precursor may be suspended or dissolved in a solvent other than water, such as an organic solvent. Non-limiting examples of organic solvents include ethanol, methanol, acetone, chloroform, pentane, cyclopentane, hexane, cyclohexane, benzene, toluene, 1,4-dioxane, diethyl ether, dichloromethane, tetrahydofuran, ethyl acetate, dimethylformamide, acetonitrile, dimethyl sulfoxide, formic acid, n-butanol, isoproponal, n-proponal, and acetic acid.

The reaction mixture comprising water and biomass in reactor 002 may comprise, without limitation, further ingredients as long as these will not inhibit the carbonization of the biomass. The pH may be in the range of about 3 to 7, more preferably 4 to 6. By adjusting the pH to the acidic range, the disintegration, in particular of polymeric compounds in the biomass, e.g. by hydrolysis may be accelerated, and the yield of activated biomass, e.g. smaller fragments may be increased. There are kinds of biomass, which are more difficult to activate than others. Wood is an example of biomass, which is quite difficult to activate. In the case of biomass, which is more difficult to activate, the pH may be adjusted to lie within the acidic range with particular benefit. The desired pH of the reaction mixture can be controlled to lie within the above ranges by adding suitable acids, which do not interfere with the activation of the biomass.

The acid is preferably a strong acid, e.g. having a pKₐ. of less than 4.5. Both, inorganic acids, e.g. mineral acids, and organic acids can be used. An example of a suitable mineral acid is phosphoric acid. Citric acid, lactic acid and pyruvic acid are examples of (strong) organic acids. According to a particular embodiment, an acid such as those exemplified above is added to the reaction mixture for the adjustment of the pH of the reaction mixture to lie in the range of 3 to 7, especially 4 to 6. The reaction mixture which may further comprise an acid can be prepared in a suitable mixer.

In alternative aspects, the reaction mixture may comprise a base, such as sodium hydroxide or potassium hydroxide. The pH of the reaction mixture may be of any exiting pH value or range as long as it is suitable for the carbonization of the carbon precursor.

Dependent on which type of biomass is used as a starting material, the particular reaction conditions in reactor 002 may be selected appropriately. In particular, for biomass which can be carbonized relatively easily in step (i), such as monosaccharides, the duration of the carbonization step may be shorter and the pH less acidic than for polymeric biomass starting material.

The heating temperature (or the reaction temperature) in reactor 002 may be kept below a selected temperature to save energy costs, while remaining sufficient to convert at least larger parts of the precursor to coal-like material. Preferably, the heating temperature is such that at least 80 wt % of the biomass gets carbonized. The heating temperature (or the reaction temperature) may be in the range of about 90 to 400° C., and it preferably is 210 to 250° C., more preferably 230 to 240° C. According to a particular embodiment, the reaction in reaction 002 involves only a single step of maintaining a single desired temperature range or alternatively two steps as described in US 2011/0056125 (incorporated herein by reference).

In the process of the invention, in particular under the above preferred reaction conditions in terms of temperature and pH, the reaction time in reactor 002 can range from about 0.1 to 48 hours. As will be appreciated, the duration of the step will depend on the kind of biomass used. Without limitation, the carbonization may be finished for instance within 1 to 3 hours. That is, within that time frame, a coal-like material of reproducible quality can be obtained. Of course, the reaction can be carried out longer or shorter if desired.

The biomass to be subjected to the first step in reactor 002 may be used in any form. Preferably, however it is divided into an appropriate particle size prior to use, e.g. in the range of 0.1 to 20 mm, more preferably 0.3 to 10 mm, especially 0.5 to 5 mm. Suitable particle sizes such as those exemplified above can be obtained by methods such as grinding, chopping or sawing.

The carbonization that occurs in reactor 002 may be construed broadly and means any reaction of molecules of the carbon precursor resulting in the built-up of larger molecules eventually yielding a coal-like material. The carbonization may include chain-growth of the monomers and inter-chain crosslinking

The reactor 002 may be a pressure resistant reactor, e.g. an autoclave or an extruder. In certain aspects, due to the water in the reaction mixture, there may be a pressure increase upon heating. As the hydrothermal carbonization reaction is exothermic, external heating may no longer be necessary, once the reaction has started, provided the thermal insulation of the reactor or reactors is sufficient.

In certain aspects, the reaction temperature may refer specifically the average temperature, inside the reaction mixture, which can be measured with a thermocouple. Thus, it may be readily possible to control the reaction temperature to lie within the desired range by heating or cooling the reactor 002, as appropriate.

The coal-like material 003, or hydrocharcoal, may be transferred from or separated from reactor 002 and enter a vessel 004 for activation into a mesoporous material. The vessel 004 may be a tubular furnace or gas reactor. The reaction temperature in vessel 004 may be at least, about or up to 20, 30, 40, 50, 60, 70, 80, 90, 100, 150, 200, 250, 300, 350, 400, 450, 500, 550, 600, 700, 800° C. or any range or value derivable therein, particularly in the range of about 300 to about 600° C. In particular aspects, the ramp to obtain the desired temperature in vessel 004 or the activation step may be a selected value or range, such as at least, about or up to 0.01, 0.1, 1, 2, 3, 4, 5, 6, 7, 8, 9, 10, 15, 20 K/min.

The activation step may involve chemical activation or physical activation, or both to impart porosity to the coal-like material. If both chemical and physical activation are used, they may be separate steps, sequential steps, or simultaneous steps. For example, the activating agent is a chemical agent, such as zinc chloride, calcium chloride, sodium hydroxide, potassium hydroxide, phosphoric acid, calcium carbonate, magnesium oxide, potassium carbonate, sodium carbonate, lithium carbonate, rubidium carbonate, cesium carbonate, sulphuric acid, nitric acid, or a combination thereof. In other aspects, the activating agent may be steam or carbon dioxide for physical activation. In particular aspects, the weight or volume ratio between the activating agent and the coal-like material may be at least, about, or up to 0.001:1, 0.005:1, 0.01:1, 0.05:1, 0.1:1, 1:1, 2:1, 3:1, 4:1, 5:1, 6:1, 7:1, 8:1, 9:1, 10:1, 50:1 or any range or value derivable therein. In a more particular aspect, the weight ratio between the chemical activating agent and the coal-like material may be about 0:01 to about 10:1.

In further aspects, the coal-like material may be treated in an inert atmosphere in vessel 004. The inert atmosphere may comprise nitrogen, helium, argon, neon, krypton, xenon, radon, or sulfur hexafluoride. In other aspects, the inert atmosphere may be vacuum. The coal-like material may be incubated at a pressure of at least, about or up to 0.01, 0.1, 1, 2, 3, 4, 5, 6, 7, 8, 9, 10, 15, 20, 30, 40, 50, 60, 70, 80, 90, 100, 150, 200, 250 kPa or any range or value derivable therein. For example, the coal-like material may be treated for activation for at least, about, or up to 0.01, 0.05, 0.1, 0.5, 1, 2, 4, 5, 6, 7, 8, 9, 10, 20 hours or any range or value derivable therein. The reactions in vessel 004 may produce a mesoporous carbon material 005.

### II. APPLICATIONS

The key industries that will find mesoporous carbon material produced according to methods described herein useful include: water, pharmaceutical, mining, industries manufacturing catalysts, environmental clean-up industries, food industry, and beverage industry.

In water industry, such material may be used for removing organic and inorganic pollutants from water, for taste and odor control, for removing natural organic matter which acts as a precursor for disinfection byproducts, or in home based filters for water purification. In environmental remediation technologies, the uses may include ground water remediation or soil remediation. The material may be used in sweetener industry for decolorization or in pharmaceutical industry for drug delivery, pharmaceutical purification, or poison abatement, in mining industry for gold recovery, in automobile industry for removing airborne pollutants in air-purification systems. The material may also be used in air purification systems, in food industry for decolorization of oils and fats, in batteries for high performance electrode materials or as catalyst support.

Particular exemplary applications of mesoporous materials prepared herein include electrode material for supercapacitors, adsorbent for carbon dioxide capture, electrode material for capacitive deionization (desalination) of brackish water, and adsorbent for sulphur removal from transportation fuels.

The carbon precursor may be any carbon-containing material. For example, the carbon precursor could be a biomass, a biomass waste, an industrial waste, and products derived from the above materials.

The term “biomass” as used herein is broadly understood as encompassing all kinds of living organism material and material derived from the same.

The biomass for use in the present invention may comprise macromolecular compounds, examples of which are lignin and polysaccharides, such as starch, cellulose, and glycogen. As used herein, the term “cellulose” is intended to encompass hemicelluloses commonly also referred to as polyoses. The term “biomass” as used herein may also include monosaccharides such as glucose, ribose, xylose, arabinose, mannose, galactose, fructose, sorbose, fucose and rhamnose, as well as oligosaccharides.

As will be appreciated, certain kinds of biomass may include either of or both, plant and animal-derived material or raw material. Examples of plant materials could be crops, agricultural food, wood, grass, leaves. Non-limiting examples of animal materials may include shells, horns, bones, teeth, beaks. Examples of materials derived from plant and animal materials could be cellulose, fructose, sucrose, lignin, hemi-cellulose, starch, chitin, keratin, collagen etc. As examples, manure (dung), night soil and sewage sludge can be mentioned.

For instance, the plant biomass may be agricultural plant material (e.g. agricultural wastes) or all kinds of wood material. Without limitation, examples of biomass are crop, agricultural food waste, feed crop residues, wood (such as wood flour, wood waste, scrap wood, sawdust, chips and discards), straw (including rice straw), grass, leaves, chaff, and bagasse. Furthermore, industrial and municipal wastes, including waste paper can be exemplified.

As is known to one of average skill in the art, “coal-like material”, as used herein, refers to a material, which is similar to natural coal in terms of property and texture. Owing to the method of the preparation thereof, it may also be referred to as hydrothermal coal. It is a product, more precisely a carbonized product that is obtained or obtainable by a hydrothermal carbonization process.

The desired product of the methods may be a mesoporous carbon material. A mesoporous material may refer to a material having mesopores contributing at least about 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 99% (or any range or value derivable therein) to the total pore volume or the total surface area. Mesopores may usually refer to between about 2 to about 50 nm in pore size or sometimes about 2 to about 100 nm in diameter.

### III. EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Material Synthesis

Schematic diagram of the synthesis procedure is illustrated in FIG. 1. Date pits are chosen as an example of waste biomass. The date pits are washed with water to remove any sticky matter and impurities. The pits are then put in the autoclave along with water at a concentration of 0.3 g/L. The autoclave is then transferred to a furnace maintained at 230° C. and left in the furnace for 2 hours.

The obtained hydrocharcoal is then impregnated with ZnCl₂ in the ratios (1:2 and 1:4 weight ratios). The ZnCl₂ impregnation is carried out by mixing the hydrocharcoal powder with 1 mg/ml solution of ZnCl₂ (containing appropriate amount of ZnCl₂ as per the weight ratio). The hydrocharcoal-ZnCl₂ solution is dried in an oven at 110° C. The ZnCl₂ impregnated hydrocharcoal is then heated in a tubular furnace under N₂ up to 450° C. at a ramp up rate of 3 K/min and held at 450° C. for 2 h. The final product is then thoroughly washed with 10 wt % HCl and finally with water until neutral pH is obtained. The samples prepared with hydrocharcoal: ZnCl₂ ratios of 1:2 and 1:4 are termed as KMC-1 and KMC-2 (where KMC stands for KAUST Mesoporous Carbon).

### Example 2

### Material Characterization

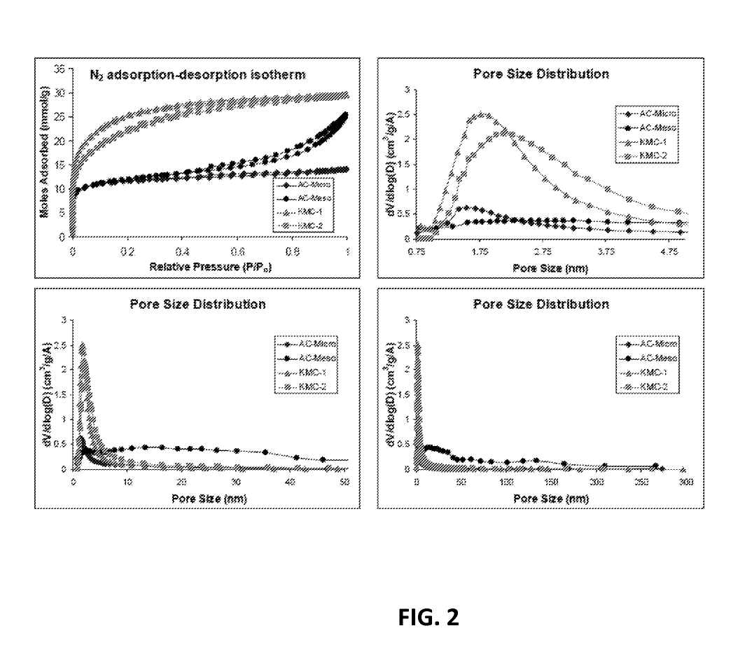

Nitrogen sorption measurements were performed on a Micromeritics TriStar II 3020 at 77.3K. The samples were degassed at 180° C. for at least 4 h before measurements were made. The N₂ adsorption-desorption isotherm and pore-size distribution for the two samples KMC-1, KMC-2 and two commercial activated carbon samples DARCO-G60 (referred to as AC-Meso) and a microporous carbon (referred to as AC-Micro) is shown in FIG. 2. The important physical characteristics for all the samples calculated from the N₂ adsorption-desorption isotherms are summarized in Table 1. The Brunauer-Emmett-Teller (BET) method was utilized to calculate the specific surface area (S_{BET}) using adsorption data up to a relative pressure value of 0.3. The total pore volume (Vt) was estimated from the N₂ adsorbed amount at a relative pressure (P/Po) of 0.992. The pore size distribution was derived from the adsorption branches of the isotherms using the Dollimore-Heal model. The mesopore surface area (Sₘₑₛₒ) and mesopore volume contribution (Vₘₑₛₒ) was determined from the cumulative surface area distribution and cumulative pore volume distribution curves respectively obtained using the Dollimore-Heal model.

TABLE 1
Structural parameters of the two commercial activated carbons and the two
mesoporous carbons synthesized in this study

| | S_{BET} | | | |
|---|---|---|---|---|
| Adsorbent | (m²/g) | Sₘₑₛₒ/Sₜₒₜₐₗ | Vₜₒₜₐₗ (cm³/g) | Vₘₑₛₒ/Vₜₒₜₐₗ |
| AC-Micro | 853 | 0.19 | 0.49 | 0.32 |
| AC-Meso | 893 | 0.35 | 0.86 | 0.59 |
| KMC-1 | 1892 | 0.35 | 1.02 | 0.46 |
| KMC-2 | 1656 | 0.52 | 1.02 | 0.66 |

### Example 3

### Sorption of Organic Compounds

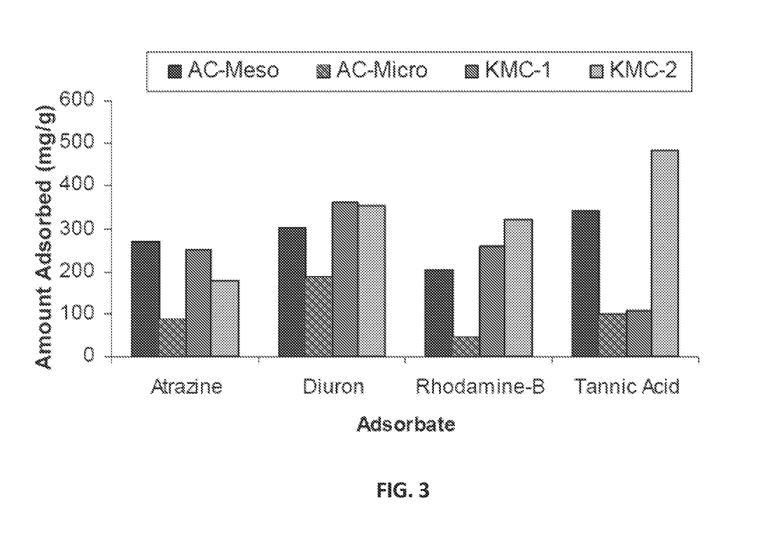

Adsorption of four organic compounds with different molecular sizes, details in Table 2, was carried out using both KMC-1,2 and the two commercial activated carbons. The organic compound sorption onto the different sorbents was determined by batch experiments. 35 ml aqueous solution of each contaminant was mixed with 2.5 mg of the sorbent in glass vials with PTFE lined caps. In the case of Tannic acid sorption, 10 mg of the adsorbent was used. The initial organic compound concentrations were fixed for each organic compound: 31.9 mg/L for diuron, 24.5 mg/L for atrazine, 80 mg/L for Rhodamine-B, and 1000 mg/L for tannic acid. The mixture were shaken on a vortex shaker for a period of 24 hours, which was determined to be sufficient for reaching sorption equilibrium. The concentration of remaining organic compound in aqueous phase was measured using Shimadzu's UV2550 spectrometer, by monitoring the absorbance at 247 nm for diuron, 221 nm for atrazine, 353 nm for Rhodamine-B, 275 nm for tannic acid. The amount of the sorbed HOCs was calculated by mass difference. The maximum sorption capacities for the different compounds on to the different sorbents is reported in FIG. 3.

TABLE 2
Selected properties of the organic compounds (adsorbate)

| | | Molecular Size | | Mol wt. |
|---|---|---|---|---|
| Adsorbate | Type | (nm) | log(Kow) | (g/mol) |
| Atrazine | Pesticide | 0.96 × 0.84 × 0.03 | 2.6 | 216 |
| Diuron | Pesticide | 1.29 × 0.77 × 0.74 | 2.8 | 233 |
| Rhodamine-B | Dye | 1.59 × 1.18 × 0.56 | 2.2 | 478 |
| Tannic Acid | Humic | Diameter = 1.6 nm | N/A | 1000-1500 |

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### REFERENCES

The following references, to the extent that they provide exemplary procedural or other details supplementary to those set forth herein, are specifically incorporated herein by reference.
U.S. Patent Publn. US 2011/0056125
Ariga et al., J. Amer. Chem. Soc., 129, 11022, 2007.
Hu and Srinivasan, Microporous and Mesoporous Mat., 43:267, 2001.
Hu et al., Advanced Mat., 12:62, 2000.
Jun et al., J. Amer. Chem. Soc., 122:10712, 2000.
Lee et al., Advanced Mat., 18:2073, 2006.
Liang et al., Angewandte Chemie Intl. Ed., 47:3696, 2008.
Meng et al., Angewandte Chemie, 117:7215, 2005.
Zhuang et al., Chem. Mat., 21:706, 2009.

What is claimed is:

1. A method for preparing a mesoporous carbon material, comprising:
a) obtaining a reaction mixture comprising a carbon precursor and a solvent;
b) incubating the reaction mixture under a pressure in the range of about 70 to about 22,000 kPa at a first temperature in the range of about 90-400° C., wherein the carbon precursor is converted to a coal-like material; and
c) treating the coal-like material with an activating agent in an inert atmosphere at a second temperature in the range of about 300-600° C., wherein the coal-like material is converted into a mesoporous carbon material.

2. The method of claim 1, wherein the mesoporous carbon material has at least about 15% contribution to the total pore volume or the total surface area by mesopores, wherein the mesopores have a pore size in the range of about 2 to about 50 nm.

3. The method of claim 1, wherein the reaction mixture has an acid.

4. The method of claim 3, wherein the acid is sulphuric acid, HCl or HNO₃.

5. The method of claim 1, wherein the reaction mixture has a base.

6. The method of claim 5, wherein the base is NaOH or KOH.

7. The method of claim 1, wherein the solvent is water or an organic solvent.

8. The method of claim 7, wherein the organic solvent is ethanol, methanol, acetone, chloroform, pentane, cyclopentane, hexane, cyclohexane, benzene, toluene, 1,4-dioxane, diethyl ether, dichloromethane, tetrahydofuran, ethyl acetate, dimethylformamide, acetonitrile, dimethyl sulfoxide, formic acid, n-butanol, isoproponal, n-proponal, or acetic acid.

9. The method of claim 1, wherein the weight percentage of the carbon precursor in the first reaction mixture is in the range of about 1 to about 99%.

10. The method of claim 1, wherein the carbon precursor is a biomass, a biomass waste, an industrial waste, a product derived therefrom, or a long chain organic compound.

11. The method of claim 10, wherein the biomass is an animal or a plant material.

12. The method of claim 1, wherein the reaction mixture is incubated in step (b) for about 0.1 to 48 hours.

13. The method of claim 1, wherein the reaction mixture is incubated in an autoclave, extruder, or a suitable pressure reactor.

14. The method of claim 1, wherein the activating agent in step (c) is a chemical agent.

15. The method of claim 14, wherein the chemical agent is zinc chloride, calcium chloride, sodium hydroxide, potassium hydroxide, phosphoric acid, calcium carbonate, magnesium oxide, potassium carbonate, sodium carbonate, lithium carbonate, rubidium carbonate, cesium carbonate, sulphuric acid, nitric acid, or a combination thereof.

16. The method of claim 1, wherein the activating agent and coal-like material are mixed in the presence of water or an organic solvent.

17. The method of claim 16, wherein the organic solvent is ethanol, methanol, acetone, chloroform, pentane, cyclopentane, hexane, cyclohexane, benzene, toluene, 1,4-dioxane, diethyl ether, dichloromethane, tetrahydofuran, ethyl acetate, dimethylformamide, acetonitrile, dimethyl sulfoxide, formic acid, n-butanol, isoproponal, n-proponal, or acetic acid.

18. The method of claim 16, wherein the mixture of the coal-like material and activating agent is further dried or used as such in step (c).

19. The method of claim 1, wherein the activating agent and coal-like material are mixed as solids.

20. The method of claim 1, wherein the activating agent is steam or carbon dioxide.

21. The method of claim 1, wherein the weight ratio between the activating chemical agent and the coal-like material is in the range of 0:1 to 10:1.

22. The method of claim 1, wherein the inert atmosphere comprises nitrogen, helium, argon, neon, krypton, xenon, radon, or sulfur hexafluoride.

23. The method of claim 1, wherein the inert atmosphere is vacuum.

24. The method of claim 1, wherein the coal-like material is treated in step (c) at a pressure of about 1 to about 200 kPa.

25. The method of claim 1, wherein the coal-like material is treated in step (c) for about 0.1 to about 5 hours.

26. The method of claim 1, wherein the ramp to obtain the second temperature in step (c) is at a rate ranging from 0.1 to about 10 K/min.

27. The method of claim 1, wherein the coal-like material is treated in step (c) in a tubular furnace or gas reactor.

28. The method of claim 1, wherein steps (b) and (c) occur sequentially.

29. The method of claim 1, further comprising:
(d) washing the mesoporous material.

30. A composition comprising the mesoporous material prepared by the method of claim 1.
